(19) United States
(12) Patent Application Publication
(10) Pub. No.: US 2015/0133569 A1
(43) Pub. Date: May 14, 2015

(54) CARBON NANOTUBE SUSPENSIONS AND METHODS OF MAKING THE SAME

(71) Applicant: Samsung SDI Co., Ltd., Yongin-si (KR)

(72) Inventors: Kuanping Gong, Fremont, CA (US); Lijie Ci, Jinan (CN)

(21) Appl. No.: 14/513,037

(22) Filed: Oct. 13, 2014

Related U.S. Application Data
(60) Provisional application No. 61/902,115, filed on Nov. 8, 2013.

(51) Int. Cl. C01B 31/02

(52) U.S. Cl. CPC C01B 31/0273
USPC 516/32; 562/89; 516/9; 516/38

(57) ABSTRACT

Carbon nanotube suspensions or dispersions include carbon nanotubes and a functionalized non-native polycyclic aromatic group attached to a surface of the carbon nanotubes. The carbon nanotubes in the suspensions or dispersions are pretreated by exposing the carbon nanotubes to a solvent (such as N-cyclohexyl-2-pyrrolidone), an acid (such as concentrated sulfuric acid), and a non-native polycyclic aromatic group. The carbon nanotubes pretreated according to this method can be dispersed or suspended in a solvent to prepare high concentration suspensions, dispersions and/or inks for various applications.

### CROSS-REFERENCE TO RELATED APPLICATION(S)

This application claims priority to and the benefit of U.S. Provisional Application No. 61/902,115 filed on Nov. 8, 2013 and entitled CARBON NANOTUBE SUSPENSIONS AND METHODS OF MAKING THE SAME, the entire content of which is incorporated herein by reference.

### BACKGROUND

Carbon nanotubes have many unique properties, including, for example, being many-fold stronger than steel, harder than diamond, more electrically conductive than copper, more thermally conductive than diamond, etc. Due to these unique mechanical, physical and chemical properties, carbon nanotubes are used in a variety of applications. For example, carbon nanotube inks, i.e., carbon nanotube dispersions, are useful for direct printing of nanotube electronics and sensors. However, the unique morphology of carbon nanotubes makes it challenging to stably disperse them in a solvent. The nanotube surfaces are attracted to each other by molecular forces, and their high aspect ratios in combination with their flexibility dramatically increase their potential for entanglement, which leads to their precipitation out of the dispersion.

Techniques for dispersing carbon nanotubes have been actively pursued. Some techniques that are currently used include mechanical or chemical cutting, suspension in specific organic solvents or superacids, dispersion with the aid of surfactants or dispersants, and covalent modification. Mechanical or chemical cutting techniques cut carbon nanotubes into fragments using mechanical force, chemical oxidation, or both. Examples of such processes include ultrasonication, ball-milling, homogenization (e.g., using homogenizers) and rotor-stator type mixing in the presence or absence of an oxidizing agent. Although shorter nanotubes are easier to disperse, cutting CNTs into shorter counterparts inevitably alters their properties, such as electrical conductivity, mechanical stability, and chemical activity, which are determined by the size, length and aspect ratio of the CNTs. Furthermore, cutting the CNTs allows external mechanical and/or chemical invasion, which consumes a significant amount of the CNTs. This invasion causes defects in the sidewalls and tips of the CNTs, for example dangling bonds, oxygen-containing groups, and vacancies. These defects often invade the conjugated backbone of the CNTs and degrade their electrical conductivity.

Dispersion or suspension of the CNTs in specific organic solvents or superacids also has limitations. For example, the solvents and superacids commonly used to disperse CNTs (such as, for example, dimethylformamide, chloroform, dichlorobenzene, N-methyl-2-pyrrolidone and chlorosulfonic acid) are typically environmentally malignant, corrosive, and have high boiling points. These features complicate the solvent-based processing of CNTs for industrial applications. Such concerns are particularly problematic for flexible CNT-based electronics, since solvents of this kind are often incompatible with the plastic and polymeric film substrates widely used in these applications.

Dispersion or suspension of CNTs with the aid of surfactants, dispersants or additives typically utilizes chemicals with dual functional groups, i.e., a tail group that can attach strongly to the nanotubes' sidewalls via a hydrophobic and/or van der Waals interaction, and a head group that is hydrophilic or charged and therefore allows nanotubes to be dispersed in solvents by electrostatic and steric repulsion. Commonly used chemicals for this purpose include sodium dodecyl sulfate (SDS), lithium dodecyl sulfate (LDS), tetradecyl trimethyl ammonium bromide (TTAB), sodium chlorate, polysaccharides, cellulose derivatives, and bio-macromolecules such as DNA and peptides. However, such non-covalent modification of the CNTs suppresses their unique benefits such as high electrical conductivity. Due to the strong adsorptive interaction between CNTs and these additives, this method requires additional steps in the processing of the CNTs, i.e., removal of the additives to recover the intrinsic nature of the CNTs, but even after the removal process, some residual additives will remain, which may degrade the performance of certain CNT-based devices that involve sensitive surface chemistry.

Methods for covalent modification of CNTs include sulfonation, halogenation, carboxylation, polymerization or diazotization, which irreversibly alter the conjugated crystalline structure of the CNTs through chemical modification. CNTs modified in this way often suffer from low conductivity, and the modifying chemicals may impede electron transfer and mass diffusion in heterogeneous reactions involving CNTs. Additionally, due to the intrinsically insufficient dispersibility of CNTs, they tend to entangle to form bundles and skeins, yielding smaller contact areas with the modifying chemicals. This significantly limits the efficiency of the covalent modification techniques.

### SUMMARY

In some embodiments, a method of pretreating carbon nanotubes includes functionalizing (e.g., sulfonating) a non-native polycyclic aromatic compound (PAC) to create a functionalized (e.g., sulfonated) PAC (e.g., PAC-SO₃), and mixing carbon nanotubes (CNTs) with the PAC-SO₃. As used herein, the term “non-native polycyclic aromatic compound” refers to a polycyclic aromatic compound that is not native to the carbon nanotubes, i.e., a polycyclic aromatic compound that is added to the surface of the carbon nanotubes through the methods discussed in this disclosure, and not an aromatic polycyclic compound that exists as part of the native structure or chemistry of the carbon nanotubes. To sulfonate the polycyclic aromatic compound, in some embodiments, the PAC is mixed with cyclohexyl-2-pyrrolidone (CHP) as a solvent and concentrated sulfuric acid (i.e., conc. H₂SO₄) as a sulfonating agent. As used herein, the term “concentrated sulfuric acid” is used in its art-recognized sense to refer to sulfuric acid that has been concentrated to a concentration of about 98% or greater. In some embodiments, this pretreatment of the carbon nanotubes may include a two-step process in which the PAC, CHP and concentrated sulfuric acid are mixed to form a solution, and then the carbon nanotubes are added to the solution. The solution may be mixed by tip sonication, and the solution may be heated to further facilitate the pretreatment reaction. Alternatively, the pretreatment may include a three-step process in which the PAC is first dispersed or immersed in CHP, then added to the concentrated sulfuric acid and mixed to form the PAC-SO₃, and then the carbon nanotubes are added to the solution. The solution containing the PAC-SO₃ and CHP (and potentially some unreacted concentrated sulfuric acid and/or PAC), as well as the final solution including the PAC-SO₃, CHP and CNTs (and potentially some unreacted concentrated sulfuric acid and/or PAC), may be mixed by tip sonication. Also, the solution of PAC and CHP, the solution of PAC-SO₃ and CHP, and/or the final solution of PAC-SO₃, CHP and CNTs, may be heated to further facilitate the respective reactions (i.e., the sulfonation reaction to create the PAC-SO₃, or the reaction of the PAC-SO₃ with the CNTs which results in the surface functionalization of the CNTs with the PAC-SO₃).

The method may further include removing the sulfonated CNTs from the solution of PAC-SO₃, CHP, and concentrated sulfuric acid by, for example, filtration. The sulfonated CNTs removed from solution may then be dried using any suitable drying technique. CNTs pretreated in this manner include PAC-SO₃ on the surfaces of the CNTs. The PAC-SO₃ compounds have strong charge-transfer and n-stacking interactions with the CNTs, which are believed to contribute to the improved dispersibility. However, the underlying CNTs themselves remain substantially unmodified, and their characteristics (including, for example, electrical conductivity) remain substantially unchanged (in comparison to corresponding untreated, raw or pristine CNTs).

According to other embodiments of the present invention, carbon nanotube dispersions, suspensions or inks include the pretreated (sulfonated) carbon nanotubes dispersed or suspended in a solvent. The pretreated carbon nanotubes in the dispersions are pretreated according to one of the methods for pretreating carbon nanotubes discussed above. The pretreatment results in carbon nanotubes having PAC-SO₃ absorbed on the surfaces of the CNTs. According to some embodiments of the present invention, a carbon nanotube ink, dispersion or suspension includes surface functionalized carbon nanotubes dispersed or suspended in a solvent. As used herein, the term “surface functionalized carbon nanotubes” refers to carbon nanotubes which have PAC-SO₃ attached to or adsorbed onto the surfaces of the carbon nanotubes, but which do not include chemical modifications to the underlying carbon nanotubes themselves.

In some embodiments, the solvent in the carbon nanotube dispersions, suspensions or inks may be water, ethanol, dimethylformamide (DMF), or propylene carbonate (PC). As noted above, the pretreatment process enables the manufacture of high concentration dispersions, suspensions or inks of carbon nanotubes. In some embodiments, for example, a dispersion of pretreated CNTs (e.g., CNTs having a length of several microns to about 50 microns) in water can have a concentration of about 0.1 mg/mL to about 2.1 mg/mL. In other exemplary embodiments, a dispersion of pretreated CNTs (e.g., CNTs having a length of several microns to about 50 microns) in propylene carbonate or ethanol can have a concentration of about 0.1 mg/mL to about 0.5 mg/mL. In yet other embodiments, dispersions of CNTs having a length of about 10 to about 20 microns in pyrrolidinone derivatives (e.g., N-butyl-pyrrolidinone, N-methyl-pyrrolidinone, and N-octyl-pyrrolidinone) can have concentrations up to about 10 mg/ml. Indeed, these high concentration dispersions can have a uniform carbon paste or an ion-liquid-like appearance (i.e., have high viscosity), and these dispersions can support even longer CNTs (e.g., synthetic, ultra-long DWNTS (double walled nanotubes) having a length of about a millimeter).

In other embodiments, a method of preparing a carbon nanotube dispersion, suspension or ink includes pretreating carbon nanotubes with sulfonated PAC (PAC-SO₃), as discussed above, and dispersing the pretreated carbon nanotubes in a solvent. In some embodiments, dispersing the pretreated carbon nanotubes may be accomplished by tip sonication.

The methods of pretreating carbon nanotubes and preparing carbon nanotube dispersions, suspensions or inks according to embodiments of the present invention enable the manufacture of high concentration carbon nanotube dispersions, suspensions or inks without the need for other additives. Additionally, the pretreatment processes according to embodiments of the present invention enable the preparation of high concentration dispersions without significantly or substantially changing the morphology or characteristics of the underlying carbon nanotubes.

### BRIEF DESCRIPTION OF THE DRAWINGS

The features and advantages of embodiments of the present invention will be better understood by reference to the following detailed description when considered in conjunction with the accompanying drawings, in which:

FIG. 1 is a flowchart depicting a pretreatment procedure according to an embodiment of the present invention;

FIG. 2 is a graph comparing the FT-IR spectra of synthetic pery-SO₃/CNT (bottom curve) to pery-SO₃ alone (upper curve) according to an embodiment of the present invention;

FIG. 3 is a mass spectrum of pery-SO₃ according to an embodiment of the present invention;

FIG. 4 is a Raman spectrum of pery-SO₃ attached to CNTs according to an embodiment of the present invention;

FIG. 5 is a graph comparing the UV-vis absorption spectra of the pery-SO₃ solution before and after impregnation with CNTs according to an embodiment of the present invention;

FIG. 6 is a graph comparing the UV-vis absorption spectra of the pery-SO₃ and pery-SO₃/CNT in water according to an embodiment of the present invention;

FIG. 7a is a low magnification transmission electron microscope (TEM) image of the pery-SO₃/CNTs according to an embodiment of the present invention;

FIG. 7b is a higher magnification transmission electron microscope (TEM) image of the pery-SO₃/CNTs of FIG. 7a;

FIG. 7c is a TEM image of pristine (i.e., untreated) single walled carbon nanotubes (SWNTs) from CheapTubes, Inc.;

FIG. 8a is a digital photograph of a solution of pery-SO₃ in water;

FIG. 8b is a digital photograph of a solution of perylene in water;

FIG. 8c is a digital photograph of a suspension of pery-SO₃/CNT in water; and

FIG. 8d is a digital photograph of pristine (i.e., untreated) CNTs in water.

### DETAILED DESCRIPTION

According to embodiments of the present invention, suspensions of carbon nanotubes include surface modified carbon nanotubes suspended (or dispersed) in a solvent. As used herein, the terms “dispersion” and “suspension,” and similar terms, are used interchangeably to refer to a solution of nanotubes in solvent in which the nanotubes are dispersed (or suspended) in the solvent. Also, as used herein, the term “surface modified carbon nanotubes,” and similar terms, refers to carbon nanotubes which have functionalized (e.g., by a sulfonate group) non-native polycyclic aromatic compounds attached to the surfaces of the carbon nanotubes, but which do not include chemical modifications to the underlying carbon nanotubes themselves. The surface modification of the CNTs enables the stable suspension or dispersion of high concentrations of carbon nanotubes in various solvents. As used herein, the term “stable dispersion” and similar terms refers to a dispersion of CNTs in which the CNTs remain substantially dispersed in the solvent, and generally do not precipitate out of the solvent over an extended period of time. Indeed, the suspensions according to embodiments of the present invention are dynamically stable systems, and the CNTs remain substantially suspended in the solvent. As noted below in the Examples, the suspensions made according to the Examples have remained substantially suspended in solution for over 3 months (i.e., with no observable sedimentation after two weeks, and only an insignificant amount of sedimentation observed after three months). After three months, the suspensions remained substantially uniformly black in color, evidencing dynamically stable systems.

As used herein, the terms “aromatic polycyclic compounds (APCs)” and “polycyclic aromatic compounds (PACs)” are used interchangeably to refer to polycyclic aromatic compounds, (as that term is understood by those of ordinary skill in the art) that are modified with a functional group (such as, for example, sulfonate). Both PACs and APCs (and similar terms) refer to compounds which include at least three fused aromatic rings. The PACs may include substituents on one or more of the aromatic rings, and/or may include additional non-aromatic, heterocyclic (i.e., a non-aromatic ring including at least one ring heteroatom, such as, for example, O, N or S) or heteroaromatic (i.e., an aromatic ring including at least one ring heteroatom, such as, for example, O, N or S) rings. Some nonlimiting examples of suitable PACs include perylene, naphthalene, acenaphthene, acenaphthylene, anthracene, benzo[a]anthracene, benzo[a]pyrene, benzo[e]pyrene, benzo[b]fluoranthene, benzo[j]fluoranthene, benzo[k]fluoranthene, benzo[ghi]perylene, chrysene, coronene, dibenz(a,h)anthracene, fluoranthene, fluorene, indeno(1,2,3-cd)pyrene, phenanthrene, pyrene, ovalene, pentacene, tetracene, triphenylene, corannulene, and the like. Additionally, PAC-containing covalent networks and metal organic frameworks may also be used as the PAC. In some embodiments, for example, the PAC may be perylene.

According to some embodiments, amorphous carbon or graphene sheets can be used instead of the PACs. In these embodiments, the amorphous carbon or graphene sheets are functionalized in the same manner as is described with respect to the PACs, and the functionalized amorphous carbon or graphene sheets are used to surface modify the underlying carbon nanotubes. Indeed, the method of pretreating the carbon nanotubes using amorphous carbon or graphene sheets is the same as that described herein with respect to pretreatment using PACs.

In some embodiments of the present invention, the surface modified carbon nanotubes are carbon nanotubes pretreated according to the methods described herein. For example, the surface modification of the carbon nanotubes may include functionalization (e.g., sulfonation) of the PACs, and attachment of the functionalized PACs to the surfaces of the CNTs, as described in more detail herein. In particular, in some embodiments, the PACs may be sulfonated, and the sulfonated PACs may be attached to the outside walls of the CNTs to form surface modified CNTs (e.g., PAC-SO₃/CNTs). The PAC-SO₃ compounds remain on the surfaces of the CNTs due to their strong charge-transfer and π-stacking interactions with the CNTs, which interactions are believed to contribute to the stability of dispersions of the surface modified CNTs. However, the underlying CNTs themselves remain substantially unmodified, and their characteristics (including, for example, electrical conductivity) remain substantially unchanged (in comparison to corresponding untreated, raw or pristine CNTs). As used herein, the term “substantially” is used as a term of approximation and not as a term of degree. For example, as used herein, the terms “substantially unmodified” and “substantially unchanged” and like terms, denote that if the characteristics of the underlying carbon nanotubes after treatment differ at all from the characteristics prior treatment, the differences are only negligible.

The solvent in the dispersion or suspension (also referred to herein, interchangeably, as an ink) of the CNTs should be stable enough for storage and transportation, and capable of suspending (or dispersing) high concentrations of carbon nanotubes. In addition, the solvent should be inert (i.e., not reactive with the carbon nanotubes, or any substrate intended to be printed with the ink), and fast drying upon printing. Some nonlimiting examples of classes of solvents that can be used to suspend the pre-treated CNTs include polar aprotic solvents, polar protic solvents, and non-polar solvents. Nonlimiting examples of suitable polar aprotic solvents include pyrrolidone derivatives, which can be used to prepare relatively high concentration CNT inks. A nonlimiting example of a non-polar solvent is hexane, which may yield a relatively low concentration CNT ink. Additionally, a mixture of solvents may be used to enhance or improve dispersability of the CNTs. For example, in some embodiments, the —SO₃H terminal of the PACs may be used for a phase transfer of CNTs to the non-polar solvent using a phase transfer catalyst.

For example, the solvent can be any suitable solvent for making CNT inks, including, but not limited to, organic or aqueous solvents, such as, for example, water, chloroform, chlorobenzene, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromomethane, diethylene glycol, diethylene glycol ethers, diethyl ether, diglyme, dimethoxymethane, N,N-dimethylformamide, ethanol, ethylamine, ethyl benzene, ethylene glycol ethers, ethylene glycol, ethylene glycol acetates, propylene glycol, propylene glycol acetates, ethylene oxide, formaldehyde, formic acid, glycerol, heptane, hexane, iodobenzene, mesitylene, methanol, methoxybenzene, methylamine, methylene bromide, methylene chloride, methyl pyridine, morpholine, naphthalene, nitrobenzene, nitromethane, octane, pentane, pentyl alcohol, phenol, 1-propanol, 2-propanol, terpineol, texanol, carbitol, carbitol acetate, butyl carbitol acetate, dibasic ester, propylene carbonate, pyridine, pyrrole, pyrrolidone, quinoline, 1,1,2,2-tetrachloroethane, tetrachloroethylene, tetrahydrofuran, tetrahydropyran, tetralin, tetra methylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, 1,4-dichlorobenzene, 1,2-dichloroethane, N-methyl-2-pyrrolidone, methyl ethyl ketone, dioxane, or dimethyl sulfoxide. As can be seen from this nonlimiting list of suitable solvents, halogenated organic solvents may be used, such as, for example, 1,1,2,2-tetrachloroethane, chloroform, methylene chloride, 1,2-dichloroethane or chlorobenzene. For example, in some embodiments, the solvent in the dispersion may be water, ethanol, propylene carbonate, or dimethyl formamide (DMF).

Additionally, the surface modification of the carbon nanotubes according to embodiments of the present invention enables the CNTs to be dispersed in more environmentally friendly, less corrosive solvents with lower boiling points. Nonlimiting examples of such solvents include water, ethanol, acetone, and propylene carbonate. For example, in some embodiments, the solvent in the dispersion is water, ethanol or propylene carbonate. According to some embodiments of the present invention, dispersions of the pretreated CNTs in non-invasive solvents, such as water or ethanol, can be used in applications requiring compatibility of the solvent with the substrate (e.g., plastic electronics, transparent conductors, solar electrodes, current collectors, etc.) or in applications requiring compatibility of the solvent with a system or separator membrane (e.g., electrodes for fuel cells, supercapacitors, batteries, etc.). In other embodiments, dispersions of the pretreated CNTs in superacids, such as chlorosulfuric acid or trifluoromethanesulfonic acid, can be used to manufacture carbon fibers or conductive glasses. In still other embodiments, dispersions of the pretreated CNTs in organic solvents, such as CHP, dimethylformamide (DMF) or toluene, can be used to manufacture CNT-based composites (such as porous filter membranes, conductive plastics, or separators for fuel cells, supercapacitors or batteries).

The surface modification of the CNTs as a result of the pretreatment processes according to embodiments of the present invention also enables the manufacture of stable dispersions or suspensions with higher concentrations of CNTs. Conventional CNT dispersions typically have a concentration of less than 0.1 mg/ml. According to embodiments of the present invention, however, the CNT dispersions including the surface modified CNTs can reach much higher concentrations in a given solvent at room temperature. For example, in some embodiments, ultra-long double-walled carbon nanotubes (DWNTs) (e.g., DWNTs with an average length up to about a mm) can be dispersed uniformly in propylene carbonate at a concentration up to 0.5 mg/mL without the help of any surfactants or other additives. In some embodiments, the addition of a polymer gel (e.g., a polymer/DMF gel) can increase the concentration of CNTs in the suspension. For example, with the help of a polymer/DMF gel, ultra-long DWNTs (e.g., those with an average length of up to about a mm) can be dispersed uniformly in propylene carbonate at a concentration up to about 1.0 w/w %. In other examples, ultra-long DWNTs (e.g., those with an average length of up to about a mm) can be dispersed uniformly in water or ethanol at a concentration up to 0.3 mg/mL without the help of any surfactants or other additives. In some embodiments, with the help of a polymer gel (e.g., a polymer/DMF gel), ultra-long DWNTs (e.g., those with an average length of up to about a mm) can be dispersed uniformly in water or ethanol at a concentration up to about 0.2 w/w %. In other embodiments, commercially available single walled CNTs (SWNTs) having an average length of about 3 to about 30 μm (e.g., available from CheapTubes, Inc.) modified according to embodiments of the present invention, can be dispersed uniformly in water at a concentration up to 2.1 mg/mL.

Any CNTs can be surface modified by the techniques according to embodiments of the present invention in order to improve the dispersibility of the CNTs. For example, the CNTs may be multi-walled (MWNTs), single-walled (SWNTs) or double-walled (DWNTs), and may have any length and aspect ratio. In some embodiments, for example, the CNTs may be multi-walled, single-walled or double-walled nanotubes having a length of about 0.5 to about 20 microns. In particular, according to embodiments of the present invention, the π-stacking of the fused aromatic rings and hydrophobic interactions of the PAC-SO₃ enable PAC-SO₃ to attach strongly to the surface of all types of CNTs. Due to the resulting electrostatic repulsion effects and hydrophilicity, attachment of the PAC-SO₃ to the CNTs enables stable dispersion of the CNTs in various solvents. According to embodiments of the present invention, the PAC-SO₃ can be used to modify the surfaces of CNTs with lengths of about a few microns to as long as a few millimeters. In addition, the PAC-SO₃ surface modification does not cause any significant change in the electrical conductivity, mechanical strength or other properties of the CNTs.

The dispersions or suspensions of CNTs pretreated according to embodiments of the present invention are stable (i.e., the CNTs generally do not precipitate out of the suspension) without the need to include additional additives, or the like. However, in some embodiments, the addition of certain additives may still be desirable. For example, additives might be desired to adjust the viscosity, pigment, or foaming of the suspension to make the suspension suitable for a particular application. Also, additives can help assembly, alignment and/or attachment of CNTs by giving them a charge, further disentangling them into individual nanotubes or smaller bundles, and/or adjusting their affinity to water or lipids. Accordingly, in some embodiments, the carbon nanotube inks (i.e., dispersions or suspensions) may further include additives, such as viscosity modifiers, pigments, defoamers, etc. Viscosity modifiers are chemical compounds capable of modifying the viscosity of the carbon nanotube ink, which may be necessary or desirable to enable printing or jetting or to make printing or jetting easier. Nonlimiting examples of suitable viscosity modifiers include glycerol. Pigments can be used to impart opacity or similar properties to the inks. Nonlimiting examples of suitable pigments include TiO₂, CaCO₃, SiO₂ and the like. Defoamers may be used to reduce the amount of foam in the ink. Nonlimiting examples of suitable defoamers include nonionic compounds, such as diols, linear alcohols or non-polar compounds.

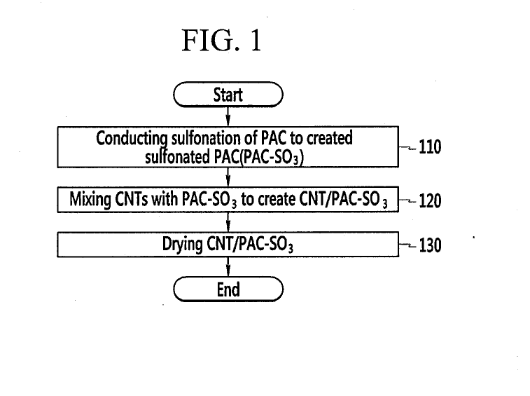

As discussed above, the carbon nanotubes in the dispersions (or suspensions) are surface modified with PAC-SO₃. In some embodiments of the present invention, raw carbon nanotubes (e.g., commercially available CNTs from, for example, Cheap Tubes, Inc., American Elements®, SouthWest Nano Technologies, Shenzhen Nanotech Port Co., Ltd. and Molecular Nanosystems, Inc.), or untreated and unpurified CNTs grown by any known method, for example, but not limited to floating catalyst chemical vapor deposition (FCCVD)) are surface functionalized by subjecting them to a pretreatment process. FIG. 1 is a flow diagram that depicts an embodiment of this process. As shown in FIG. 1, the method according to some embodiments of the present invention generally includes sulfonating the PACs to create PAC-SO₃ (110), mixing the PAC-SO₃ with the CNTs to create CNTs with PAC-SO₃ attached on the surfaces of the CNTs (120), and optionally drying the modified CNTs (130).

In some embodiments, for example, the pretreatment process includes dissolving, dispersing, immersing or suspending PACs in N-cyclohexyl-2-pyrrolidone (CHP). In some embodiments, in place of the CHP, a CHP analogue, N,N-dimethyl formamide, dimethyl sulfoxide, methyl pyridine, tetrahydrofuran, or the like may be used. Nonlimiting examples of suitable CHP analogues include dimethyl-tetrahydro-2-pyrimidinone, N-butyl-pyrrolidinone, benzyl-pyrrolidinone, N-methyl-pyrrolidinone, 3-(2-oxo-1-pyrrolidinyl)propanenitrile, N-ethyl-pyrrolidinone, N-octyl-pyrrolidinone, N-vinyl-pyrrolidinone, dimethyl-imidazolidinone, dimethyl-acetamide and N-dodecyl-pyrrolidone. The pretreatment process further includes adding concentrated sulfuric acid (H₂SO₄) to the CHP/PAC solution or suspension. Upon adding the sulfuric acid to the CHP/PAC solution, the PAC reacts with the sulfuric acid to install a sulfonate functional group on the PAC resulting in a PAC-SO₃ compound. The pretreatment process further includes adding the raw CNTs to the PAC-SO₃/CHP solution. Upon adding the CNTs to this solution, the PAC-SO₃ attaches to the surfaces of the CNTs.

In some embodiments, the PACs are first dispersed in the CHP, and then the CHP/PAC solution is mixed with concentrated sulfuric acid (H₂SO₄) at an elevated temperature. In some embodiments, in place of the concentrated sulfuric acid, chlorosulfuric acid or oleum (i.e., H₂SO₄+20% SO₃) may be used. In some embodiments, the elevated temperature may be about 50° C. to about 200° C., for example about 85° C. In some embodiments, the sulfuric acid treatment is conducted at a temperature of about 50° C. to about 200° C. for about 1 hour to about 150 hours. For example, in some embodiments, the sulfuric acid treatment is conducted at about 85° C. for about 24 hours. Any suitable mixing means may be used to facilitate the treatment. For example, stir bars can be utilized. The CHP and sulfuric acid can be used in any suitable ratio (even pure sulfuric acid), and the amount of the PACs can be any amount, and may be as high as possible as long as the solution remains capable of dispersing CNTs. This process installs sulfonate groups on the PACs, yielding a solution of CHP and PAC-SO₃ (i.e., a CHP/PAC-SO₃ solution).

The CNTs are then added to the CHP/PAC-SO₃ solution and mixed at room temperature. This process installs the PAC-SO₃ on the surfaces of the CNTs, yielding a CNT/PAC-SO₃ product. The PAC-SO₃ functionalized carbon nanotubes may then be rinsed and dried to substantially remove the solvent. As discussed above, as used herein, the term “substantially” is used as a term of approximation, and not as a term of degree. In particular, as used herein, “substantially remove the solvent” refers to the removal of most of the solvent from the treated CNTs, but that some trace amounts of the solvent may remain after the removal process. The carbon nanotubes pretreated in this manner can be stably dispersed in various solvents (e.g., water, ethanol, dimethylformamide (DMF), propylene carbonate (PC), etc.) to form stable dispersions or suspensions, as discussed above.

Tip-sonication may be used to disperse the raw CNTs in the CHP/PAC-SO₃ solution during the pretreatment process. The tip-sonication can be performed for any suitable amount of time until the desired dispersion is achieved. In some embodiments, for example, the CNTs are tip-sonicated in the CHP/PAC-SO₃ solution for about 10 minutes to about 1 hour (depending on the size and amount of the CNTs) to prepare a suitable dispersion of the CNTs in the CHP/PAC-SO₃ solution. For example, in some embodiments, the CNTs are tip-sonicated in the CHP/PAC-SO₃ solution for about 30 minutes to prepare a suitable dispersion of CNTs in the CHP/PAC-SO₃ solution. Other suitable dispersion techniques (other than tip-sonication) include bath sonication, stirring and shaking. Indeed, any dispersion technique capable of wetting and dispersing the CNTs for efficient contact with the PAC-SO₃ may be used.

As noted above, according to some embodiments of the present invention, the PACs are first immersed in CHP, which serves to solubilize the PACs. The PACs are then sulfonated by mixing the CHP/PAC solution with concentrated H₂SO₄, which installs hydrophilic functional groups (i.e., SO₃H groups) on the PACs. This pretreatment process yields CNTs with improved dispersibility in various solvents, including water and various organic solvents.

However, the PAC functionalization process is not limited to such a two-step process, and the functionalization can be conducted in one step. In such an embodiment, the PACs, CHP and concentrated sulfuric acid are mixed together at the same time, and then heated at the same temperature described above with respect to the two-step process. The one-step process can also include heating the mixture over the same duration as described above for the two-step process. However, in some embodiments, the one-step process includes a longer heating period. For example, in some embodiments, the one-step process may include a heating period that is about 4 hours longer than the heating period used in the two step process. In particular, in some embodiments, the heating period used in the one step process may be about 1 hour to about 200 hours (depending on the amount and distribution of PACs in the solution).

In some embodiments, the dispersibility of CNTs modified by PAC-SO₃ can be adjusted by adjusting the loading of SO₃H⁻. For example, when increased dispersibility is desired, a higher loading amount of SO₃H⁻ in the PAC-SO₃ may be used. Conversely, when decreased dispersibility is desired, the sulfo-aromatic compounds (PAC-SO₃) can be reversibly carbonized in concentrated H₂SO₄ at a temperature greater than 200° C., or in an inert atmosphere at a higher temperature to reduce the loading amount of SO₃H⁻.

In some embodiments, perylene may be used as the PAC. For example, perylene may be sulfonated using CHP and concentrated sulfuric acid (H₂SO₄). In some embodiments, the perylene is first mixed with CHP and H₂SO₄ at an elevated temperature for an amount of time sufficient to yield sulfonated perylene (pery-SO₃) having the desired SO₃H⁻ loading. The mixture can then be cooled to ambient temperature. The pery-SO₃ may be used to pretreat CNTs by the one-step or two-step process described above. For example, in some embodiments, the pery-SO₃ may be mixed with the CNTs to absorb the pery-SO₃ onto the CNTs. The CNTs may then be separated from the mixture, and then washed and dried. This pretreatment process yields CNTs with improved dispersibility in various solvents, including water and various organic solvents. Indeed, the separated CNTs may be suspended in the desired solvent to the desired concentration to prepare an ink or suspension useful in the desired application.

The pretreatment process according to embodiments of the present invention can be used to pretreat any CNTs, for example, short CNTs with lengths of a few microns (e.g., about 0.1 microns to about 5 microns, for example, about 3 μm) to long CNTs with lengths of several microns to several millimeters (e.g., about 30 microns to about 10 mm). Regardless of the length or type of CNTs (e.g., single walled, double walled, or multi-walled), the pretreatment process according to the present invention enables stable dispersion or suspension of the CNTs in various solvents without compromising or substantially affecting the length or conjugated structure of the CNTs.

Additionally, the pretreated carbon nanotubes according to embodiments of the present invention can be dispersed in various solvents (e.g., water and various organic solvents as discussed in more detail above) at high concentrations without the need for additional additives, surfactants, or polymers. The critical concentration of a CNT ink or dispersion for most industrial applications is 0.1 mg/ml. Historically, however, it has proved challenging to make a stable dispersion or suspension having this critical concentration. As used herein, the term “stable dispersion” and similar terms refers to a dispersion of CNTs in which the CNTs remain substantially dispersed in the solvent, and generally do not precipitate out of the solvent. However, the CNT dispersions according to embodiments of the present invention in which the CNTs are pretreated according to the above described pretreatment processes can achieve concentrations in various solvents that are even higher than the critical concentration of 0.1 mg/ml. Specifically, in some embodiments, dispersions of CNTs in water can reach concentrations as high as 0.3 mg/mL, and in other embodiments, dispersions of CNTs in propylene carbonate can reach concentrations as high as 0.5 mg/mL. Also, according to embodiments of the present invention, these high concentration dispersions can be achieved using either commercially available short CNTs (e.g., having a length of a few microns) or synthesized long CNTs (i.e., having a length of a few millimeters).

The following Examples A-D and Comparative Example A illustrate certain exemplary dispersions and processes. However, it is understood that these Examples are presented for illustrative purposes only, and do not limit the scope of embodiments of the present invention.

### Example A

### Preparation of Pery-SO₃

100 mL concentrated H₂SO₄ was heated to 85° C. in one container. In another container, 50 mg of perylene was dissolved in 50 mL of CHP to yield a solution with a concentration of 1.0 mg/mL. The perylene-CHP solution was then dropwise added to the heated H₂SO₄ and maintained at 85° C. overnight to ensure a good yield of sulfonated perylene (pery-SO₃). Next, the mixture was cooled to ambient temperature to provide a pery-SO₃ solution useful for modification of CNTs.

### Example B

40 mg of SWNTs having a length of about 3 to about 30 microns, an outer diameter of about 1 to about 4 nm and a purity of greater than 99% (from CheapTubes, Inc.) were added to the pery-SO₃ solution of Example A, and the pery-SO₃ was allowed to absorb onto the CNTs yielding a new adduct, i.e., a pery-SO₃/CNT composite. The mixture was then filtered to isolate the solid pery-SO₃/CNT composite, and the isolated pery-SO₃/CNT composite was dried and characterized using Fourier transform infrared spectroscopy (FT-IR), Raman spectroscopy, Transmission electron microscopy (TEM) and UV-vis spectroscopy. The isolated pery-SO₃/CNT composite was also rinsed with water, and the effluent was collected for analysis of the amount of pery-SO₃ absorbed onto the CNTs (i.e., the effluent was analyzed to assess the amount of pery-SO₃ in the effluent which is indicative of the amount not attached to the CNTs). The effluent was then condensed by rotating evaporation using a rotary evaporator at 50° C. and characterized using FT-IR and Matrix-assisted laser desorption/ionization-Time-of-flight mass spectrometry (MALDI-TOF MS). The interaction of pery-SO₃ with the CNTs was monitored using UV-vis spectroscopy.

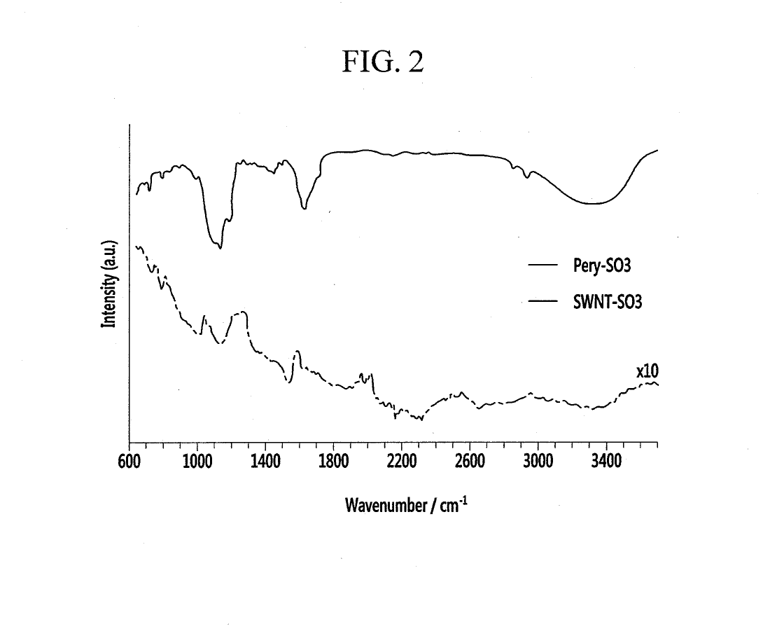

FIG. 2 is a graph comparing the FT-IR spectra of the synthetic pery-SO₃/CNT composite of Example B (bottom) and the pery-SO₃ alone of Example A (upper). As shown in FIG. 2, the pery-SO₃ of Example A displays two sharp peaks at 1187 cm⁻¹ and 1138 cm⁻¹, and a relatively broadened peak at 1050 cm⁻¹, which can be attributed to the stretching of the 0=S=0 bond and to SO₃H, respectively. In addition, the stretching of sp2 carbon in the pery-SO₃ appeared at 1632 cm⁻¹, which is about a 30 cm⁻¹ upshift relative to that of perylene. See Spectral Database for Organic Compounds, SDBS, http://riodb01.ibase.aist.go.jp/sdbs/cgi-bin/direct_frame_top.cgi. This confirms that perylene was successfully sulfonated. Like the pery-SO₃ alone, the pery-SO₃/CNT composite of Example B exhibits two well-defined peaks in the same wavenumber range, i.e., one is centered at 1136 cm⁻¹, and the other at 1040 cm⁻¹. This signals the formation of the pery-SO₃/CNT adduct. The CNT component caused the characteristic peaks of the SO₃H group to shift downward and became broadened somewhat, indicating a strong charge transfer interaction between the two components.

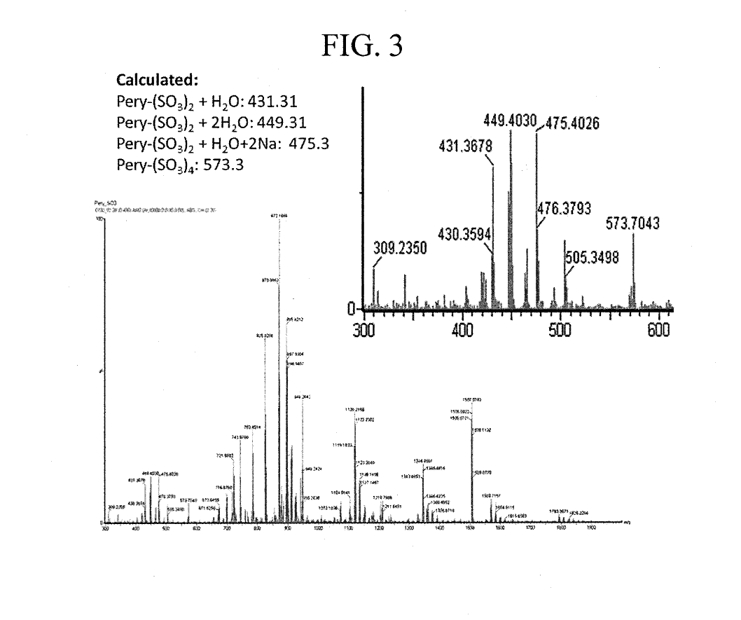

FIG. 3 shows the mass spectrum (MS) for the pery-SO₃ of Example A. In the m/z range of 300 to 600, it was apparent that the peaks at 431.3678, 449.4030, 475.4026, and 573.3 can be indexed to [pery-(SO₃)₂+H₃O⁺, cal. 431.31], [pery-(SO₃)₂+H₂O+H₃O⁺, cal. 449.31], [pery-(SO₃)₂+H₃O⁺+2Na, cal. 485.31], and [pery-(SO₃)₄+H⁺, cal. 573.31], respectively. This MS response is consistent with the calculated values for perylene sulfonic acid, which indicates that the sulfonation reaction was efficient and resulted in a mixture of double- and tetra-sulfonated perylene.

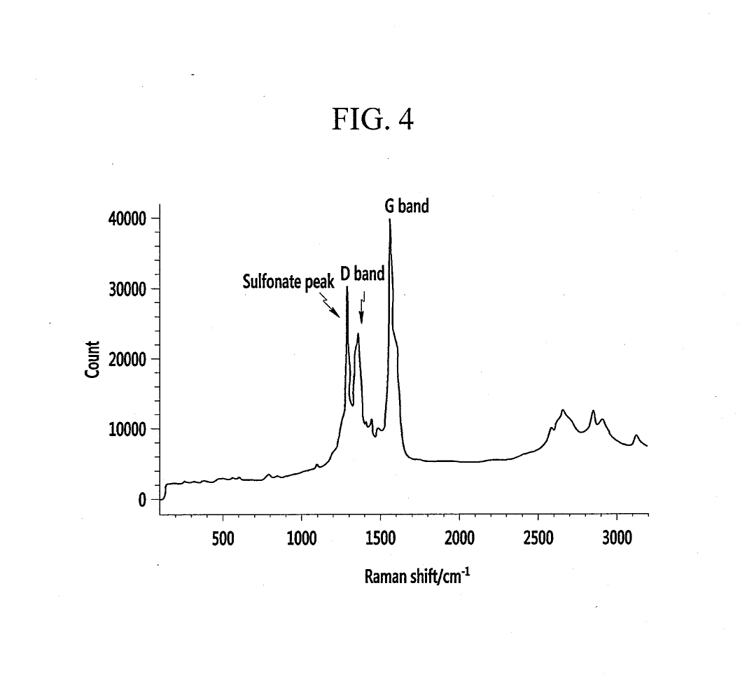

FIG. 4 shows the Raman spectrum for the pery-SO₃/CNT of Example B. Referring to FIG. 4, the pery-SO₃/CNT composite shows a relatively high ratio of the D band intensity to the G band intensity, i.e. I_{D}/I_{G}, indicating changes to the CNT structure. In addition, the pery-SO₃/CNT composite exhibits an additional peak at 1270 cm⁻¹ compared to the Raman spectrum of the SWNTs (from CheapTubes, Inc.) alone, confirming attachment of the SO₃H groups to the CNTs.

### Example C

To further study the interaction between the pery-SO₃ and the CNTs, a sample was prepared according to the procedure of Example B, except that the SWNTs were mixed with the pery-SO₃ of Example A for two hours before being filtered (by a disk filter with a 0.45 micron pore size) to separate the solid pery-SO₃/CNT composite. The solution remaining after filtration (i.e., the filtrate) was analyzed by UV-vis absorption spectroscopy and the resulting UV-vis spectrum (i.e., of the pery-SO₃ after absorption to the CNTs) was compared with the UV-vis spectrum for pery-SO₃ alone (i.e., before absorption to the CNTs).

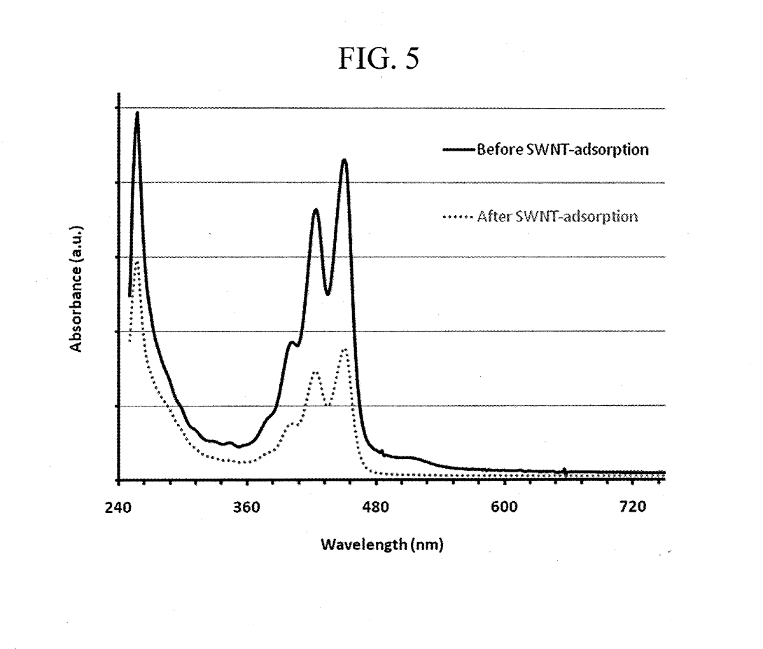

FIG. 5 shows a comparison between the UV-vis absorption spectra of the pery-SO₃ of Example A and that of the filtrate from the sample of Example C. As can be seen in FIG. 5, the pery-SO₃ absorption intensity decreased by two thirds after being mixed with CNTs for 2 hours. Without being bound by any particular theory, it is believed that this decrease in absorption intensity may be due to the extraction of pery-SO₃ by CNTs in forming the pery-SO₃/CNTs adduct via van der Waals forces and hydrophobic interactions.

### Example D

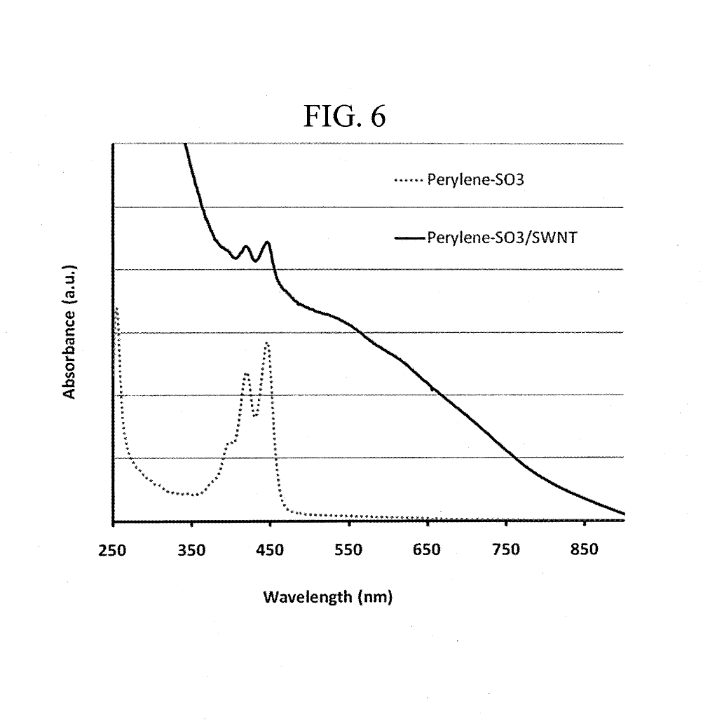

To further confirm the strong interaction between pery-SO₃ and CNTs, the solid pery-SO₃/CNT composite obtained according to Example C was dispersed in water at a concentration of 0.5 mg/ml. FIG. 6 compares the UV-vis absorption spectra of the pery-SO₃ of Example A and the pery-SO₃/CNT composite dispersion in water of Example D. As can be observed in FIG. 6, the UV-vis absorption spectrum of the pery-SO₃ shows three characteristic peaks between 350 to 500 nm, and the spectrum of the pery-SO₃/CNT composite exhibits all the three characteristic peaks of pery-SO₃. The absorption intensity is stable over an extended period of, for example, 2 hours. These observations suggest a robust interaction between pery-SO₃ and CNTs.

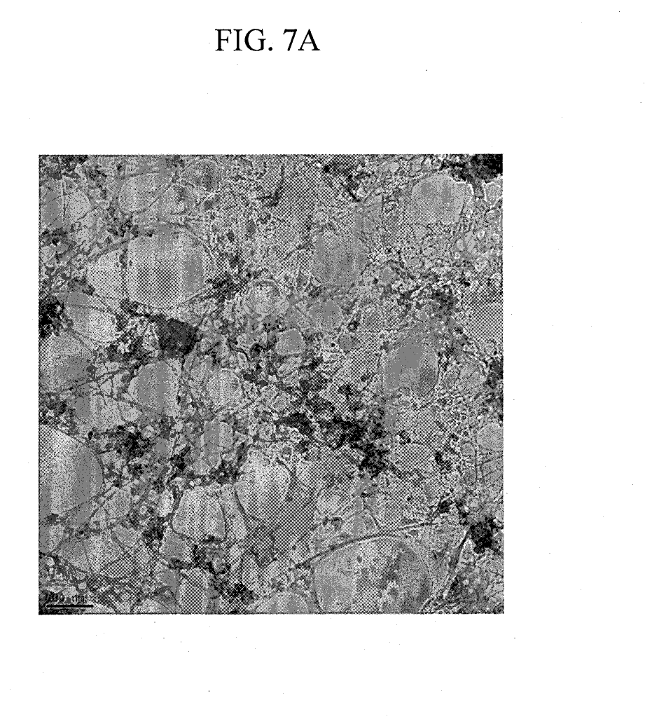

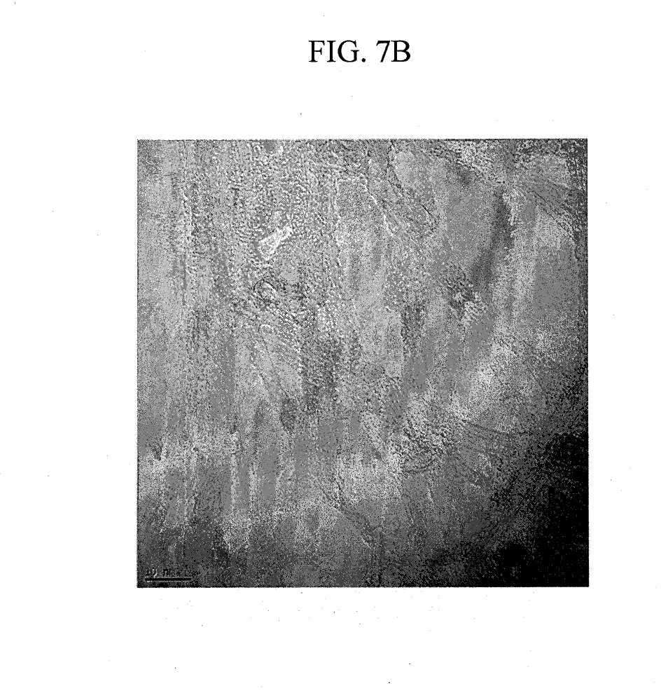

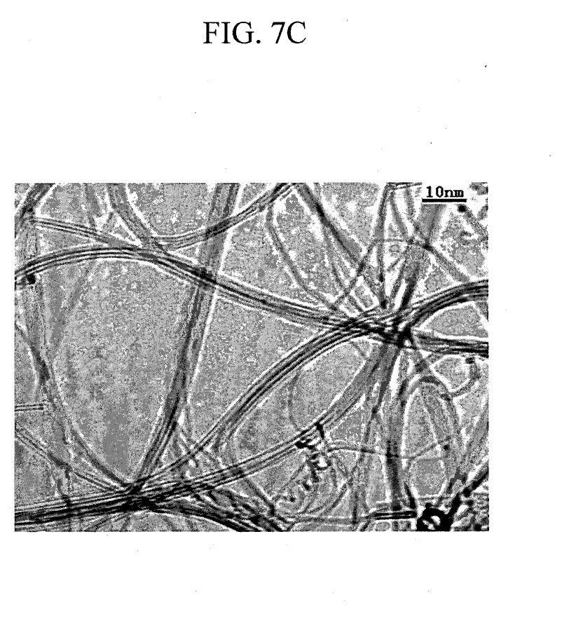

FIGS. 7a-7c show TEM images of the pery-SO₃/CNT composite of Example C and pristine (i.e., unmodified) CNTs (from CheapTubes, Inc). A comparison of the TEM images of the pery-SO₃/CNT composite (FIGS. 7a and 7b) and the commercial (unmodified) CNTs (FIG. 7c) shows that the sulfonation reaction produced an amorphous nanocoating on the nanotubes' surface. Furthermore, the individual nanotubes can be clearly observed in the high magnification TEM image (FIG. 7b), indicating a good suspension of the pery-SO₃/CNT composites in water, which further confirms the ability of hydrophilic polycyclic compounds to disperse CNTs.

### Comparative Example A

Pristine (i.e., commercially available and unmodified) SWNTs (from CheapTubes, Inc.) were added to water and the mixture was tip-sonicated for 30 minutes to prepare a dispersion having a concentration of 5 mg SWNTs in 50 ml water.

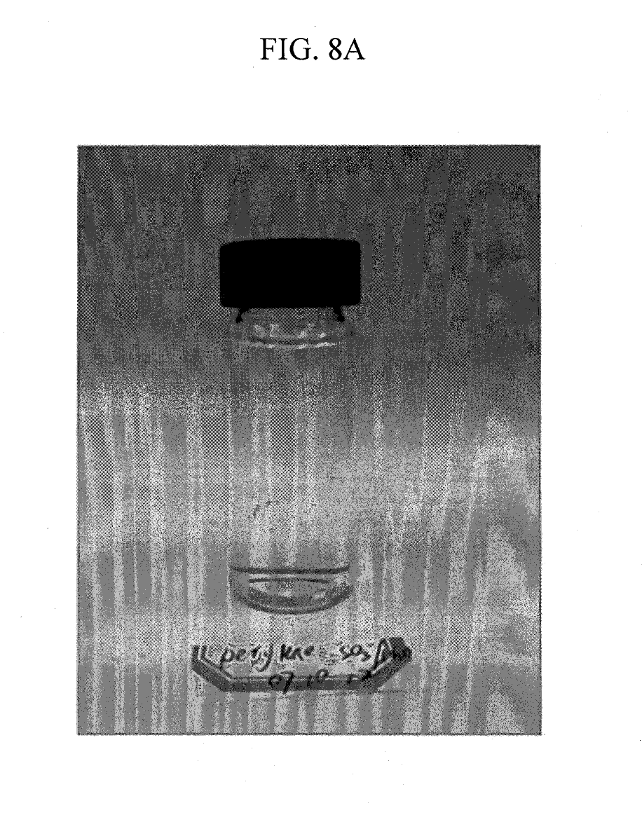

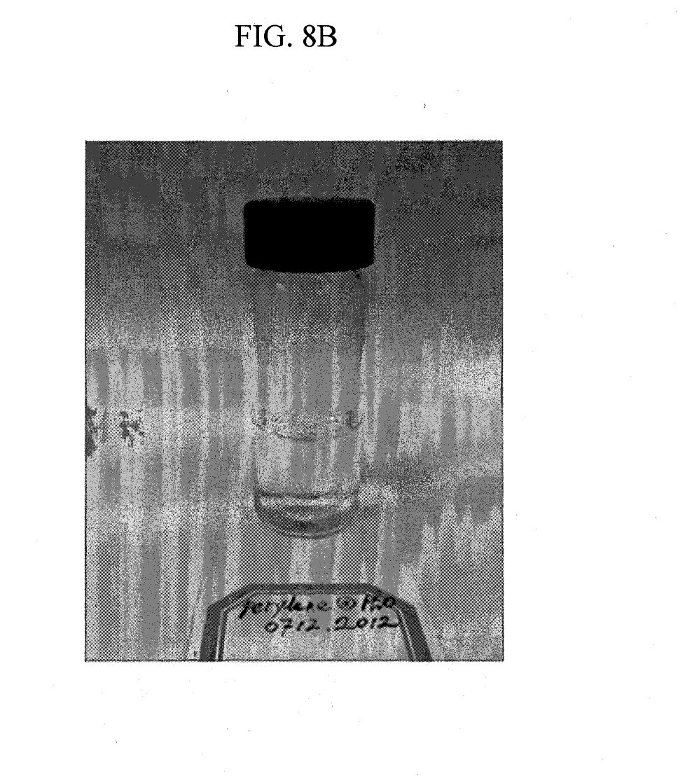

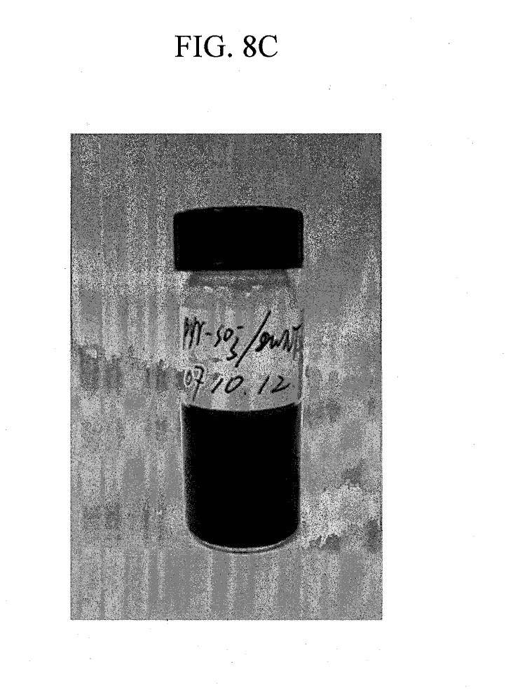

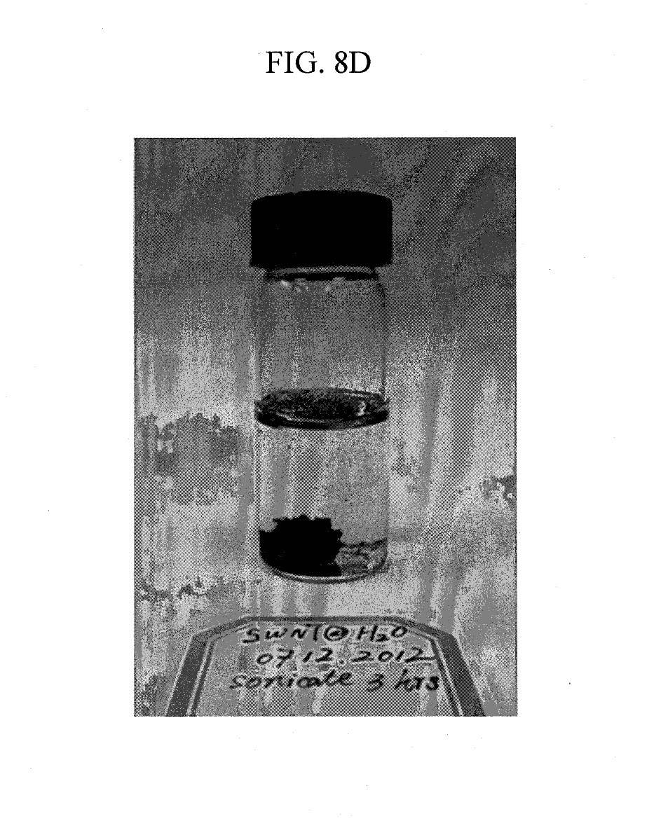

FIGS. 8a-8d are digital photographs of the pery-SO₃ of Example A in water at a concentration of 0.5 mg/ml (FIG. 8a), perylene in water at a concentration of 0.5 mg/ml (FIG. 8b; note that the insoluble perylene is floating on the water in this figure), the pery-SO₃/CNT composite of Example D in water at a concentration of 0.25 mg/ml (FIG. 8c), and the pristine (unmodified) CNTs of Comparative Example A in water at a concentration of 0.25 mg/ml (FIG. 8d). As can be observed in FIGS. 8a-8d, the pery-SO₃/CNT composite of Example D forms a uniform dispersion in water (FIG. 8c), and the pery-SO₃/CNT composite remained uniformly dispersed in the water for the entire 3-week long study. In contrast, the suspension of the unmodified CNTs of Comparative Example A (FIG. 8d), which was prepared with the help of sonication, showed a significant amount of CNT sediment after standing quiescently for only one hour. The pery-SO₃/CNT suspension in water (FIG. 8c) had good dispersibility and suspension stability because of the strong interaction between the pery-SO₃ and the CNTs, and the amphiphilic properties of the pery-SO₃.

While certain exemplary embodiments of the present invention have been illustrated and described, it is understood by those of ordinary skill in the art that certain modifications and changes can be made to the described embodiments without departing from the spirit and scope of the present invention, as defined in the following claims. For example, while the CNTs are generally described herein as surface modified by the attachment of “PAC-SO₃” on the surfaces of the CNTs, it is understood that the “PAC-SO₃” modifier can instead be sulfonated amorphous carbon or sulfonated graphene sheets that are attached to the surfaces of the CNTs. Indeed, as used herein, the term “PAC-SO₃” refers not only to sulfonated polycyclic aromatic compounds, but also to sulfonated graphene sheets and sulfonated amorphous carbon. Also, although the surface functionalization of the CNTs is described above as including sulfonation of a PAC, amorphous carbon or graphene sheet, it is understood that other functional groups (i.e., functional groups other than SO₃) can also be used. Additionally, as used throughout this disclosure, the term “about,” and similar terms, is used as a term of approximation, not as a term of degree, and reflects the penumbra of variation associated with measurement, significant figures, and interchangeability, all as understood by a person having ordinary skill in the art to which this invention pertains.

What is claimed is:

1. A composition comprising:
carbon nanotubes; and
a functionalized non-native polycyclic compound attached to surface of the carbon nanotubes.

2. The composition of claim 1, wherein the functionalized non-native polycyclic aromatic comprises a —SO₃H functional group on a non-native polycyclic aromatic compound.

3. The composition of claim 1, wherein the functionalized non-native polycyclic aromatic compound comprises functionalized perylene.

4. The composition of claim 1, wherein the functionalized non-native polycyclic aromatic compound comprises peryene functionalized with a —SO₃H functional group.

5. The composition according to claim 1, further comprising a solvent.

6. The composition according to claim 5, wherein the solvent comprises a solvent selected from the group consisting of water, ethanol, dimethylformamide, propylene carbonate, pyrrolidinone derivatives, and combinations thereof.

7. The composition according to claim 6, wherein the solvent comprises water.

8. The composition according to claim 6, wherein the solvent comprises ethanol or propylene carbonate.

9. A method of treating carbon nanotubes, the method comprising:
exposing the carbon nanotubes to a solvent selected from the group consisting of N-cyclohexyl-2-pyrrolidone, an analogue of N-cyclohexyl-2-pyrrolidone, N,N-dimethyl formamide, dimethyl sulfoxide, methyl pyridine, tetrahydrofuran, and combinations thereof;
exposing the carbon nanotubes to an acid selected from the group consisting of concentrated sulfuric acid, chlorosulfuric acid, oleum, and combinations thereof; and
exposing the carbon nanotubes to a non-native polycyclic aromatic compound.

10. The method according to claim 9, wherein the analogue of N-cyclohexyl-2-pyrrolidone comprises a compound selected from the group consisting of dimethyl-tetrahydro-2-pyrimidinone, N-butyl-pyrrolidinone, benzyl-pyrrolidinone, N-methyl-pyrrolidinone, 3-(2-oxo-1-pyrrolidinyl)propanenitrile, N-ethyl-pyrrolidinone, N-octyl-pyrrolidinone, N-vinyl-pyrrolidinone, dimethyl-imidazolidinone, dimethyl-acetamide, N-dodecyl-pyrrolidone, and combinations thereof.

11. The method according to claim 9, wherein the exposing the carbon nanotubes to the solvent, the exposing the carbon nanotubes to the acid, and the exposing the carbon nanotubes to the non-native polycyclic aromatic compound are performed in a single step, the single step comprising mixing the solvent, the acid, the non-native polycyclic aromatic compound and the carbon nanotubes to form a carbon nanotube-solvent-acid-polycyclic aromatic compound solution.

12. The method according to claim 11, further comprising heating the carbon nanotube-solvent-acid-polycyclic aromatic compound solution.

13. The method according to claim 12, wherein the carbon nanotube-solvent-acid-polycyclic aromatic compound solution is heated at a temperature of about 50° C. to about 200° C.

14. The method according to claim 11, further comprising filtering the carbon nanotubes from the carbon-nanotube-solvent-acid-polycyclic aromatic compound solution.

15. The method according to claim 9, wherein the exposing the carbon nanotubes to the solvent, the exposing the carbon nanotubes to the acid, and the exposing the carbon nanotubes to the non-native polycyclic aromatic compound comprises first mixing the solvent with the non-native polycyclic aromatic compound to form a polycyclic aromatic compound-solvent solution, then mixing the polycyclic aromatic compound-solvent solution with the acid to form a polycyclic aromatic compound-solvent-acid solution, and then adding the carbon nanotubes to the polycyclic aromatic compound-solvent-acid solution to form a polycyclic aromatic compound-solvent-acid solution-carbon nanotube solution.

16. The method according claim 15, further comprising heating the acid prior to mixing the polycyclic aromatic compound-solvent solution with the acid.

17. The method according to claim 16, wherein the acid is heated at a temperature of about 50° C. to about 200° C.

18. The method according to claim 15, further comprising filtering the carbon nanotubes from the polycyclic aromatic compound-solvent-acid-carbon nanotube solution.

19. The method of claim 9, wherein the non-native polycyclic aromatic compound comprises perylene.

20. The method of claim 15, wherein the non-native polycyclic aromatic compound comprises perylene.
